(19) United States
(12) Patent Application Publication
(10) Pub. No.: US 2006/0277170 A1
(43) Pub. Date: Dec. 7, 2006

(54) Digital library system

(76) Inventors: Paul Watry, Wirral (GB); Robert Sanderson, Wirral (GB); Ray Larson, Richmond, CA (US)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/448,347

(22) Filed: Jun. 6, 2006

Related U.S. Application Data
(60) Provisional application No. 60/688,180, filed on Jun. 6, 2005.

(51) Int. Cl. G06F 17/30

(52) U.S. Cl. 707/3

(57) ABSTRACT

An information retrieval application is disclosed which supports digital library functionality, including information retrieval, information manipulation and processing, in distributed data environments (e.g. Grid computing). The application is based on an object model in which data objects (for example, PDF documents) are represented as records in canonical XML form using a schema. These records are stored, distributed around a network, and may be queried using the Common Query Language. Processing objects (for example, preparsers and parsers) may be used to transform data objects into XML records or other data objects, or XML records into one or more data objects. This application defines workflows as objects which can call other workflow objects, allowing for the creation of powerful and flexible parallel configurations.

### CROSS-REFERENCE TO RELATED APPLICATIONS

The present patent application claims priority from U.S. Provisional Patent Application No. 60/688,180, filed on Jun. 6, 2005.

### TECHNICAL FIELD

The present disclosure relates to a digital library system that will operate in both single-processor and “Grid” distributed computing requirements.

### BACKGROUND

In order for Information retrieval (IR) in the evolving “Grid” parallel distributed computing environment to work effectively, there must be a single flexible and extensible set of “Grid Services” with identifiable objects and a known Application Program Interface (API) to handle the information retrieval functions needed for digital libraries and other retrieval tasks.

The present disclosure describes a digital library system which uses an object model to define three classes of objects (data, processing, and abstract) each with precisely defined roles. With a common identifier scheme for objects in the system, this object model will permit information retrieval methods typical of digital libraries to be distributed over nodes on a network, increasing the throughput of data for compute and storage intensive processes with little overhead beyond existing single processor solutions.

In this way, the disclosed object model may be used to support a number of the back-end functions of digital library services within a data grid environment, including methods of data backup, automated replication, and archive; the support for data curation systems layered on top of localized storage; and the use of data grid technologies to federate digital library services.

### SUMMARY OF THE INVENTION

In accordance with a first aspect of the present invention, there is a digital library system implemented as a set of distinct functional elements comprising the following:
parser, for receiving a digital object in any of a set of external formats and parsing it to create a Record in a format compatible with other elements of the system;
record: the parsed form of a digital object;
index: a set of terms extracted from a record;
database: a logical collection of records and indexes;
query: a query parse tree;
the system supporting an ingest process in which externally generated digital objects are parsed to create records which are stored as such by the system, and terms are extracted from the records to create an index, and a discovery process, in which a result set is generated by mapping a query onto the Indexes associated with at least one database.

In accordance with a second aspect of the present invention, there is a digital library system implemented in an object oriented environment and comprising objects of three classes: (1) data objects, which represent data and storage; (2) process objects, which represent processes performed upon data; and (3) additional abstract objects, wherein
the set of data objects includes (a) records, representing externally generated digital objects and encoded in a data format compatible with other objects in the system; (b) indexes, which represent a set of terms extracted from a record; (c) queries, which represent a query from a user; and (d) result sets, which represent the results of a query for return to the user;
the set of processor objects includes (a) pre-parsers, which convert externally generated data objects, whose format may be incompatible with other objects of the system, to a chosen common data format; (b) at least one parser, which processes documents output from the pre-parsers to create records; (c) at least one extractor, which extracts data of a chosen format or type for indexing;
the set of abstract objects includes (a) at least one database, which represents a logical collection of records and indexes; (b) workflows, which take data input, carry out a user-defined sequence of processing steps, and produce output; and (c) at least one server, which represents a logical collection of databases.

### BRIEF DESCRIPTION OF THE DRAWINGS

Specific embodiments of the present invention will now be described, by way of example and not limitation, with reference to the accompanying drawings, in which:

FIG. 1 is a schematic representation of a system embodying the present invention;

FIG. 2 is a schematic representation of an ingest process implemented by the system;

FIG. 3 is a schematic representation of a discovery process implemented by the system; and

FIG. 4 is a schematic representation of workflow in an embodiment of the system based upon grid processing.

### DETAILED DESCRIPTION OF A PREFERRED EMBODIMENT

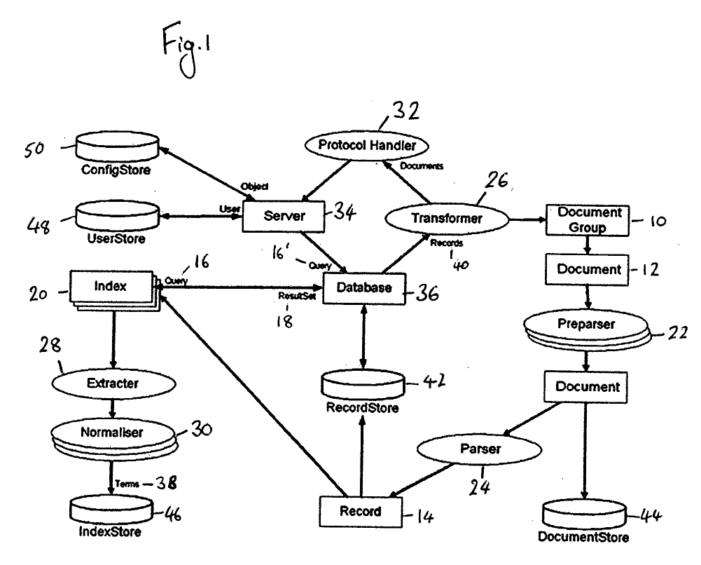

In the drawings, white rectangles are data objects. White ovals are processing objects. Hatched rectangles are abstract objects. Three dimensional cylinders are data storage objects. Stacked grey ovals represent zero or more instances of that type of object. Some objects in FIG. 1 are represented as names at the ends of arrows.

Data objects are those which represent some collection or item of data. Processing objects represent some function to be performed on a data object. Abstract objects represent virtual collections of objects. Data storage objects represent some means of making a data object persist.

Briefly summarized, the present disclosure describes an information retrieval application which supports digital library functionality in a data grid environment. The application uses an object-oriented design with an object hierarchy consisting of two main object types: objects which represent data and storage; and objects which represent processes. An additional abstract object type is described.

The main data objects include:
DocumentGroup 10: A set of documents
Document 12: An unparsed data representing a single item
Record 14: A parsed XML-based data representing a single item
Query 16,17: A CQL query parse tree
Resultset 18: An ordered set of symbolic pointers to records
Index 20: An ordered list of terms extracted from a Record
User: An authenticated user of the system.

Storage facilities exist for each of these object classes.

The main processing groups include:
Preparser 22: Converts a Document into another type of Document
Parser 24: Converts a Document into a Record
Transformer 26: Converts a Record into a Document
Extractor 28: Extracts data of a given format or type for indexing
Normalizer 30: Converts data from one format or type to another
Protocol Handler 32: Takes a request in a known protocol and converts to to an internal representation.

The three abstract objects comprise:
Server 34: A logical collection of databases
Database 36: A logical collection of records and indexes
Workflow 40, 41: An object that can take input, go through a user-defined sequence of processing steps, and produce output.

The object model uses a single master and multiple slave processes distributed to different processors over a high speed network. The workflow object is the component which will permit the application to work effectively in a distributed environment.

All configuration of the object model and its processes is done using XML-configuration specifications. Using the object model described, these may be treated as data record objects and distributed through the normal chain of operations using protocols such as OAI-MHP for bulk harvesting or SRW/U for search and retrieval.

The object model disclosed will permit each instantiation of the architecture to use the same configuration store and simply build the objects as part of their normal operation, instead of transferring code to each of the distributed nodes to perform tasks (such as indexing or searching).

The architecture comprises a database object, defined as a logical collection of records and indexes, which can be split across many nodes, or combined at a single location, so that each node on the cluster can look after a part of the database or do the processing required and then return the record for central storage.

The architecture comprises a workflow object model which can take input, go through a user defined sequence of processing steps, and produce output, such that a) each instantiation of the architecture can use the same configuration store and simply build the objects as part of their normal design, instead of transferring code to each of the distributed nodes to perform tasks (such as indexing and searching); b) each workflow object can invoke other workflow objects by identifier (using the common identifier scheme) to split tasks into easily maintainable segments; c) multiple databses can each use the same primary workflow object for processing a request and can also invoke other database-specific workflow objects for other operations (for example, in converting an incoming document to the internal record format); d) once a workflow object has completed its task at the remote node, it can return the information it has generated back to the main process, if necessary, as a response to the initial request.

The following facilities are used in the present embodiment of the invention and will be familiar to the person skilled in the art:

XML (Extensible Markup Language)

Xpath (XML Path Language)

SAX (Simple API for XML)

DOM (Document Object Model)

CQL (Common Query Language)

OAI-MHP (Open Archives Initiative)

SRW/SRU (Web service for search and retrieve).

The various object types used in the present embodiment will now be described in more detail.

Data Objects

A DocumentGroup 10 represents a collection of one or more digital objects. The format and content of these, and their origin, can be very diverse. They may be textual, numeric, image, video, audio or other types of data. DocumentGroups can also represent unknown digital objects, such as the results of a search on a remote database. The DocumentGroup 10 maintains metadata about the collection of digital objects, such as how many there are. DocumentGroups 10 allow the extraction of the individual digital objects as Documents.

A Document 12 represents a single digital object in any format. It allows the extraction of the raw data from that digital object and maintains metadata about it, including a unique identifier and the processing it has undergone.

A Record 14 represents a parsed XML form of a digital object which was previously maintained as a Document. It allows for interaction with the parsed XML in terms of various standard interfaces such as SAX and DOM. It also allows for retrieval of the XML tree in the standard serialised form.

Index objects 20 represent a collection of Term objects, described below, and the XPath expressions required to extract the base information from the XML Record. They are responsible for processing the extraction and normalisation workflow, and providing access to the extracted terms during the discovery phase.

Term objects 38 represent a single term extracted from a Record, along with its location, frequency and other metadata. They are just static data and do not have any functional requirements.

Query objects 16, 17 represent a user supplied information discovery request in CQL form. The system maps CQL indexes to Index objects in order to process the request.

ResultSet objects 18 represent an ordered collection of pointers to Record objects. They are the result of evaluating a Query against Index objects. The pointers are ResultSetItem objects, which maintain their ranking information along with the reference to the Record that they represent.

Processing Objects

PreParsers 22 take a document and transform it into a different document according to some specification. For example, one of the library of PreParsers 22 takes a PDF document and returns the raw text. Another takes the text and converts all of the extended characters into XML character entities. PreParsers thus have one function: to process a document. Libraries of PreParsers are known in the art and commercially available.

Parser 24 accepts a Document which contains unparsed XML in its normal serialised form. It then creates a Record object 14 which represents the parsed form of the XML. Parsers have one function: to process a Document into a Record.

By virtue of the PreParsers 22 and Parser 24, the system is able to receive data from any of a wide range of sources in a correspondingly wide range of formats, converting such data into a common format, which in the present embodiment is XML.

Transformer objects 26 are the opposite of Parsers. They accept a Record object 40 and turn it into a Document of some description. Other types of Transformer turn one Record 40 into multiple Documents in the form of a DocumentGroup 10. For example an XSLT stylesheet Transformer may process the XML record according to the stylesheet. Alternatively the Transformer 26 may split a very long Record into multiple component Documents. Transformers have one function: to process a Record 40 into a Document or DocumentGroup 10.

Extracters 28 are responsible for locating information within data extracted from the Record by the Index 20. For example, a DateExtracter would search through the data given to it for dates, whereas a KeywordExtracter would turn the data given to it from a single string into keywords. Extracters 28 have three different interfaces, all of which produce the same output—a list of Terms 38. These interfaces depend on the type of data to process: one processes raw strings, a second is for serialised SAX events and the third is for DOM nodes.

Normaliser objects 30 are the equivalent of PreParsers 22 for Terms 38. They accept a Term and return the term after some processing. Example normalisers include ones that reduce all case of the terms to lower case, perform stemming on the term, or regularise different date formats.

ProtocolHandler objects 32 provide interfaces to the system. They are responsible for accepting and parsing input from some source and turning it into a form which the rest of the system can then process. Once the system has processed the request, the ProtocolHandler 32 then returns the information as appropriate. Examples of well known ProtocolHandlers 32 include web site interfaces, information retrieval protocols such as OAI, SRW or Z39.50 or dedicated graphical user interfaces.

Abstract Objects

Servers 34 are responsible for maintaining the objects within the system, and are primarily an abstract collection of Database objects. The ProtocolHandlers 32 interact directly with a server to fulfill requests from the user. The Server's main responsibility in this regard is to provide authentication for the user before handing the request on to the appropriate database for processing.

Databases 36 are each an abstract collection of Records, which are maintained in a RecordStore 42, and their associated Index objects. The Database 36 maintains metadata about the Record collection, such as its size, the average size of the Records within it and so forth.

Storage Objects

These objects are all very similar with respect to functionality. They persist the type of object for which they are responsible. RecordStores 42 maintain Record objects; DocumentStores 44 maintain Documents; IndexStores 46 maintain Indexes; UserStores 48 maintain user information and ConfigStores 50 maintain configurations for other objects.

Instantiations may vary from storing the data in a relational database, to directly in the filesystem or in a remote data store.

Configurations and Object Instantiation

Non-data objects are configured via an XML description using an extensible schema to accommodate the different classes' requirements. This base schema includes the type of object to instantiate and an identifier for it, along with space for settings, paths and permission requirements. Configurations may be either loaded from file, or parsed and stored as Record objects in a customised RecordStore that can automatically build the object on demand. By storing object configurations as Records, we can use existing functionality to process, locate and distribute them. For example, in a large or distributed system, object properties could be indexed to create a searchable registry.

Any configuration can have a series of sub-configuration files. Typically, the server will maintain globally useful objects such as a default Parser, commonly used Transformers and PreParsers, along with top level objects such as Databases, ObjectStores, ResultSetStores and so forth. Each Database, for example, can then maintain their own Store objects, and any customised processing objects.

Object identifiers are guaranteed to be unique only within the context of their parent object. This means that multiple databases can have an object with the same identifier. Also, object identifiers defined in a sub-configuration will override an identifier created at a higher level. For example, a Database could define an object called ‘PartOfSpeechPreParser’ which would be used in place of the object with the same identifier defined in the Server.

Server Build Process

When the server is created, it is given a pointer to a configuration file. This can either be a file stored on an accessible file system, or a pointer to a remote service from which to retrieve the configuration. The configuration is parsed and the type of object to build is extracted, along with any modules that need to be imported. The system then finds the code for the object type and uses a dynamic load system to create the object instance.

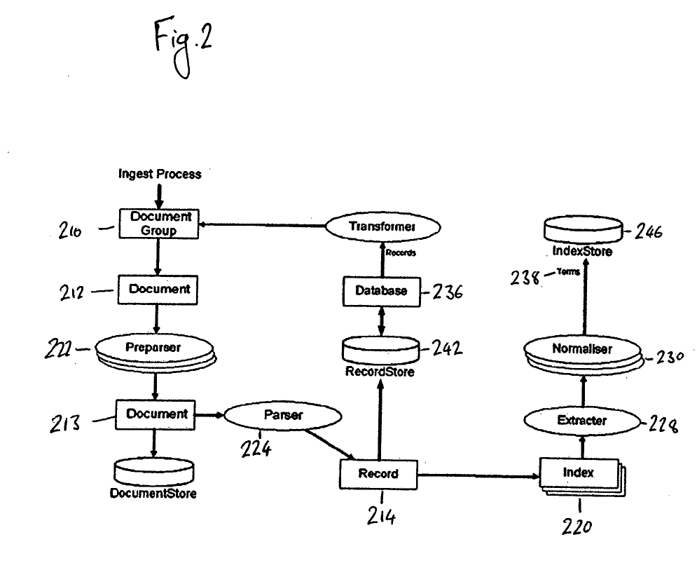

Ingest Process (FIG. 2)

The ‘ingest’ process is the phase in which data comes into the system for storage and processing. The typical process starts with a DocumentGroup 210. The individual Documents 212 are extracted and put through a series of PreParser steps 222 to end up with the correct XML Document 213. Any of these Documents may be stored in a DocumentStore. This is then given to Parser 224 to create a Record 214. The record is given to a RecordStore 242 for persistence, to a Database 236 to add to its list of included records, and then to each Index 220 known to the Database 236. The Index 220 extracts the values from the specified XPath locations, then gives the results to an Extracter 228, followed by zero or more Normalisers 230 to get the Terms 238 into their final form. The normalisation process may also include dereferencing of remote documents, and include a new Document or DocumentGroup back into the process. The Terms are then stored in an IndexStore 246.

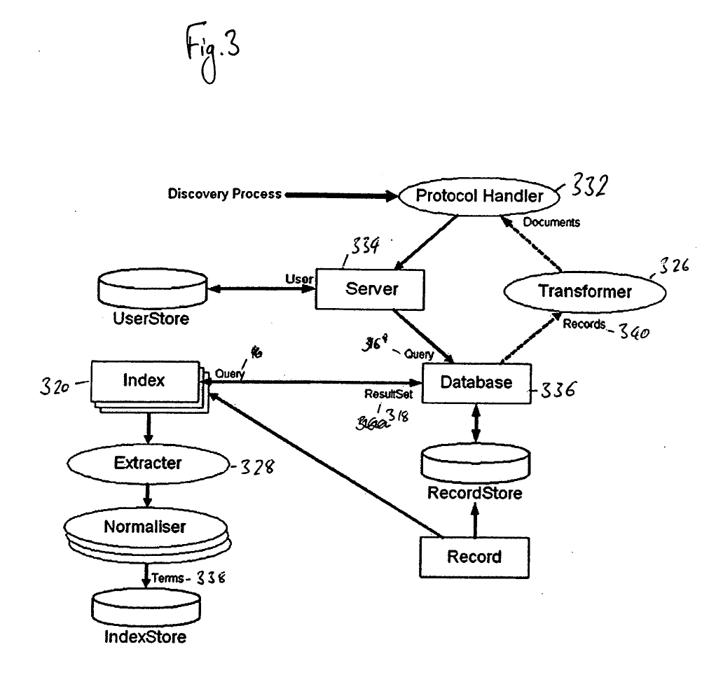

Discovery Process (FIG. 3)

The discovery process is initiated via a request to a ProtocolHandler 332 which then hands the parsed request off to a Server 334 to process. The Server 334 attaches any authentication information into the session for the Request, and hands it off to one or more Databases 336 for processing. The Databases 336 then look at the Query 316 and map from the Query's representation into the Database's known Indexes 320. Each Index then extracts Terms 338 from the Query as if it were a string result of an XPath expression, in order to ensure that the Terms from the Query and the Terms extracted from the Records are comparable. The Index 320 then compares the Query Terms against its known Terms and creates an interim ResultSet 318. This ResultSet is merged with other ResultSets from other Indexes, according to the boolean operators in the Query. This may be the final result of the process, or the Records 340 referenced by the ResultSetItems may be retrieved and transformed with a Transformer 326 into a Document before being returned to the user via the ProtocolHandler 332.

Workflow Objects

The system is very flexible as to how the components can be used in conjunction with each other. For example, very different services can be created very easily by using different orders of the same processing objects or different configurations of the same type of object. The flow of data through the system is therefore very important to be able to easily control.

As the system's model is easy to understand and it is easy to create new implementations of the main processing objects (PreParsers, Transformers, Normalisers), it is also important that the flow of data be able to be sent to objects unknown to the original programmers of the system.

A Workflow object may used to control the flow of the data objects throughout the system. This can either be considered a processing object as it takes a data object and acts upon it, or an abstract object as an ordered collection of other objects. It is configured, stored and instantiated in exactly the same way as all other objects in the system. It has an identifier unique to the context in which it is defined.

The base object schema is extended for workflows to allow a series of instructions to be recorded. These instructions are typically the identifiers for objects to process the data, or logical flow control such as looping, branching and event handling. Instead of an identifier, the workflow may specify a type of object. In this case the default object of that type for the context is used. For example, a workflow to process the Ingestion phase might know to give the Record object to a RecordStore, rather than to the RecordStore with a given identifier. This allows for generic workflows to be written, rather than very specific ones.

When the Workflow object is instantiated, the schema is processed and dynamically compiled into executable code. This code is then assigned to the object in order to process requests. In this way, Workflows act at the same speed as any other programming instructions and there is no disadvantage to using them over writing the code by hand. This is also important as it allows for non-programmers to control the data flow of a service.

As the results of any function are well defined, the result of a Workflow is also well defined. This means that the result of one Workflow can be passed to another Workflow which expects the same input as the first Workflow's output.

Given that Workflows are themselves objects with a known means of interaction, one Workflow may reference one or more other Workflows as part of its processing instructions. For example, an Ingestion workflow might reference a PreParserWorkflow to maintain the pre-parsing steps in a different workflow to the main ingestion steps.

As Workflows have the same identification scheme as other objects, the Server may define very high level Workflows, and allow the individual databases to override the identifiers as required. The PreParserWorkflow described above might have zero steps in the Server context, but the Databases would then override this object to implement their specific processing requirements.

Workflows as objects also share the same portability. They can be stored in configuration stores and retrieved and interacted with via the same means as with Records that represent data objects.

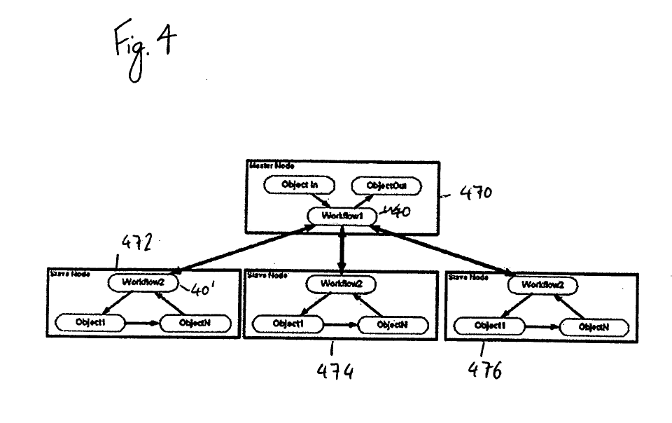

Grid Processing (FIG. 4)

The main problem of grid scale information retrieval is controlling the flow of data across the machines that perform the processing. In information retrieval, this is especially important as it is very data intensive as opposed to other grid applications which are often more calculation intensive. By using Workflows and the ease of distribution of object configurations, the system is able to overcome these hurdles.

Each processing node 470, 472-476 in the cluster or grid builds the same object infrastructure by retrieving the configurations from the master configuration store, or by reading them from a network-mounted file system. Then one or more nodes 470 are selected as ‘master’ nodes which execute high level Workflows. These Workflows then distribute the processing to other nodes, called ‘slaves’, by sending the identifier of the Workflow to process and the input object for it. This communication happens via a ProtocolHandler which implements a distributed processing protocol such as PVM, MPI, SOAP or XML-RPC.

Once the slave node has finished processing the Workflow, it returns the result to the master. As this result is well defined, and either Null or an object, the communication is relatively straightforward. Configured objects can be referenced by their identifier, stored data objects can be referenced by their data store and identifier within the store in the same way as a ResultSetItem. This means that the data may only needs to be shipped in one direction—from the master to the slave.

This abstraction also allows for easy configuration of subdivision of the database. If each node maintains its own RecordStore, then the Records will be partitioned across the grid for storage and retrieval. If each node maintains its own IndexStore, then the terms will be partitioned across the grid. Equally, a node's IndexStore might maintain all of the terms for all of the Records for only one Index.

What is claimed is:

1. A digital library system implemented as a set of distinct functional elements comprising the following:
parser, for receiving a digital object in any of a set of external formats and parsing it to create a Record in a format compatible with other elements of the system;
record: the parsed form of a digital object;
index: a set of terms extracted from a record;
database: a logical collection of records and indexes;
query: a query parse tree;
the system supporting an ingest process in which externally generated digital objects are parsed to create records which are stored as such by the system, and terms are extracted from the records to create an index, and a discovery process, in which a result set is generated by mapping a query onto the Indexes associated with at least one database.

2. A digital library system as claimed in claim 1, wherein the discovery process yields a record which is itself available to be indexed and included in a database for subsequent discovery processes.

3. A digital library system as claimed in claim 1, further comprising an extractor function which extracts data of a selected format or type from a record for inclusion in an index.

4. A digital library system as claimed in claim 1, wherein the parser function comprises a preparser function which receives the digital object and converts it to a chosen data format, and a main parser function which processes the resulting document to provide the record in a form compatible with other functional elements of the system.

5. A digital library system as claimed in claim 4, comprising a library of preparsers for converting digital objects in respective different formats to the chosen data format.

6. A digital library system as claimed in claim 4 wherein the chosen data format is XML.

7. A digital library system as claimed in claim 1, further comprising a record store for storing the records.

8. A digital library system as claimed in claim 1, further comprising an index store for storing the indexes.

9. A digital library system as claimed in claim 1, further comprising a transformer function which accepts a record in the common data format and transforms it to a different data format for supply to a user or to an external system.

10. A digital library system as claimed in claim 1, wherein data flow through the system is managed by means of at least one workflow process which receives input data, performs a user-defined sequence of steps, and produces output data.

11. A digital library system as claimed in claim 10, implemented on a grid of processor nodes, wherein distinct workflow processes are allocated to respective nodes.

12. A digital library system as claimed in claim 11, wherein one node implements a master workflow process and a set of further nodes implement respective slave workflow processes, the slave workflow processes serving to pass their output data to the master.

13. A digital library system as claimed in claim 10 which supports calling of one workflow process by another.

14. A digital library system implemented in an object oriented environment and comprising objects of three classes: (1) data objects, which represent data and storage; (2) process objects, which represent processes performed upon data; and (3) additional abstract objects, wherein
the set of data objects includes (a) records, representing externally generated digital objects and encoded in a data format compatible with other objects in the system; (b) indexes, which represent a set of terms extracted from a record; (c) queries, which represent a query from a user; and (d) result sets, which represent the results of a query for return to the user;
the set of processor objects includes (a) pre-parsers, which convert externally generated data objects, whose format may be incompatible with other objects of the system, to a chosen common data format; (b) at least one parser, which processes documents output from the pre-parsers to create records; (c) at least one extractor, which extracts data of a chosen format or type for indexing;
the set of abstract objects includes (a) at least one database, which represents a logical collection of records and indexes; (b) workflows, which take data input, carry out a user-defined sequence of processing steps, and produce output; and (c) at least one server, which represents a logical collection of databases.

15. A digital library system as claimed in claim 14, which supports an ingest process in which an externally generated digital object is processed by a pre-parser to create a corresponding document in the common data format, which is processed by a parser to create a record which is stored by the system.

16. A digital library system as claimed in claim 15, wherein the ingest process further comprises addition of the record to the list of included records in one or more databases.

17. A digital library system as claimed in claim 16, wherein the ingest process further comprises supply of the record to indexes referenced by the database, extraction of index terms by an extractor, and storage of the index terms.

18. A digital library system as claimed in claim 14 which supports a discovery process in which an index extract terms from a query and compares them against the indexes known terms to create a sub-result set.

19. A digital library system as claimed in claim 18, wherein the discovery process further comprises mapping of a query by a database onto the known indexes of the database, and merging of sub-result sets from multiple databases, according to logic specified in the query, to create a result set.

20. A digital library system as claimed in claim 18 which further comprises a protocol handler, the discovery process being initiated via a request to the protocol handler, which passes the query to a server to process, the server in turn passing the request to one or more of the databases which it references and the databases mapping the query onto the indexes known to the database to create respective sub-result sets, which are then merged with other sub-result sets to create the result set.

21. A digital library system as claimed in claim 18, wherein the discovery process further comprises retrieval of the records referenced by the result set for provision to a user.

22. A digital library system as claimed in claim 21, wherein the set of processor objects further comprises at least one transformer which serves to convert a record to a document in a different data format.

23. A digital library system as claimed in claim 22, wherein the discovery process further comprises transformation of the records referenced by the result set by means of a transformer to a different data format.

24. An object model for a digital library system implemented in a distributed, object oriented environment, comprising objects of the following types:
objects representing data and storage, including (a) records, representing externally generated digital objects and encoded in a data format compatible with other objects in the system; (b) indexes, which represent a set of terms extracted from a record; (c) queries, which represent a query from a user; and (d) result sets, which represent the results of a query for return to the user;
objects representing processes performed upon data, including (a) pre-parsers, which convert externally generated data objects, whose format may be incompatible with other objects of the system, to a chosen common data format; (b) at least one parser, which processes documents output from the pre-parsers to create records; (c) at least one extractor, which extracts data of a chosen format or type for indexing;
the set of abstract objects includes (a) at least one database, which represents a logical collection of records and indexes; (b) workflows, which take data input, carry out a user-defined sequence of processing steps, and produce output; and (c) at least one server, which represents a logical collection of databases.

25. A method of implementing digital library functionality in a data grid environment, resulting in increased throughput of data for compute and storage processes with little overhead beyond single processor solutions, comprising: a) an information retrieval system which will operate in both a single-processor and data grid processing environments; b) support for a common identifier scheme for objects in the system to distribute digital library functionality over many nodes in a network; c) the transformation of existing digital library infrastructures into appropriate architectures for grid-based systems; d) an object model which uses a single master and multiple slave processes distributed to different processors over a high speed network in order to work efficiently in a distributed processing environment.

26. The method according to claim 25, further comprising a distributed object model consisting of three object types, as follows: a) objects which represent data and storage (DocumentGroup, Document, Record, Query, ResultSet, Index); b) objects which represent processes (PreParser, Parser, Transformer, Extractor, Normalizer); and c) additional abstract objects (server, database, and workflow).

27. The method according to claim 26, wherein the data objects DocumentGroup and Document are configured as single data object (Record) in canonical XML form using a schema.

28. The method according to claim 27, wherein the index of a single data object (Record) may be extracted and queried using the Common Query Language (CQL).

29. The method according to claim 28, wherein the querying of an index will generate a data object (ResultSet), defined as an ordered list of pointers to single Record objects.

30. The method according to claim 29, wherein an Extractor processing object will extract terms from a ResultSet object.

31. The method according to claim 30, wherein a Normalizer processing object will return a normalized form of a terms generated through the Extractor processing object.

32. The method according to claim 30, wherein processing objects (PreParser and Parser) are configured to return parsed Record objects from a ResultSet object.

33. The method according to claim 32, wherein a Transformer processing object will generate a document object from a parsed record object in XML form.

34. The method according to claim 33, defining an abstract object (Workflow) defined in XML and converted to Python code when the object is built; a single Workflow object can call other Workflow objects.
